(19) United States
(12) Patent Application Publication
(10) Pub. No.: US 2011/0320438 A1
(43) Pub. Date: Dec. 29, 2011

(54) RULE SUMMARY

(75) Inventor: Michael Tofinetti, Ottawa (CA)

(73) Assignee: Alcatel-Lucent Canada, Inc., Ottawa (CA)

(21) Appl. No.: 12/826,320

(22) Filed: Jun. 29, 2010

(51) Int. Cl. G06F 17/30

(52) U.S. Cl. 707/722; 707/E17.014

(57) ABSTRACT

A rule summarizing engine and method is disclosed for traversing functional relations in a telecom database and rendering the functional relations in human readable form. The rule summarizing engine and method obtains a database of rules established by operators using a Graphical User Interface to establish functional relations between conditions and actions in a telecom network device. The rule summarizing engine end method traverses either an indicated portion or the entire database and renders the functional relations hitherto established into a readily readable structured form. The rule summarizing engine and method is particularly useful for assisting error finding in functional relations established in a telecom database over other methods known in the art.

### FIELD OF THE INVENTION

The invention relates to an apparatus and method for producing rule summaries and is particularly concerned with producing rule summaries from databases assembled from Graphical User Interfaces.

### BACKGROUND OF THE INVENTION

Graphical User Interfaces (GUIs) are often used in management of operational information in telecommunications networks.

Although the Graphical User Interface can be an optimum operator interface to an item of Network Equipment, the accumulation of data structures in a Network Equipment database is generally not in a form readily assessable by human operators.

In one kind of Network Equipment used in an LTE Mobile network, a Graphical User Interface is used to establish rules and conditions for dynamically controlling and managing all data sessions and providing appropriate interfaces towards charging and billing systems. As a result of operator inputs via a GUI, a series of interconnected rules are established in a database rendered in the Java language.

Within the constructed database rules there are objects name “rules” that contain several conditions (such as “Option=‘A’”) together with an action to be taken when the conditions are satisfied. Further, these rules are assembled into Rule Tables which contain multiple rules. In some tables the rules are assessed in a strict order, such that as soon as the conditions for a given rule are satisfied, the actions corresponding to that rule are taken and subsequent rules for that table are not further assessed.

As the overall collection of Rules Tables are assembled by the automatic software upon input from the Graphical User interface, the subsequent database structure is not in a form readily cognizable by human operators. Tracing the relations among the database objects is error prone, and the database structure is not conducive to easy error checking.

Therefore it would be useful to have some means to reconstitute the total set of rules constituted in a database in a form readily cognizable by human operators.

### SUMMARY OF THE INVENTION

It is an object of the invention to provide an apparatus and method for rendering the rules stored in a network equipment database in a form readily cognizable by a human operator.

According to an aspect of the invention there is provided a method for translating functional relations among objects within a network equipment database into a format more readily cognizable by an operator; the method having the steps of receiving a database having objects corresponding to functional rules for a corresponding network equipment element, wherein the objects were established via an operator using a graphical user interface; traversing at least a portion of objects within the database, the traversing following the functional relations among the portion of objects; and generating an output document which reformats the functional relations into a user readable format.

In some embodiments, the objects comprise statements in the Java language.

In some embodiments, the invention further has the steps of displaying the output document on a video display, while in other embodiments there may be the further step of rendering the output document on a hard copy generating device.

In yet other embodiments, there is the additional step of specifying the at least a portion of objects via operator intervention. The specifying step may specify a Rule table, or alternatively a Rule set.

In another embodiment of the invention, there is provided a rule summarizing engine for translating functional relations among objects within a network equipment database into a format more readily cognizable by an operator, the rule summarizing engine having a processor for executing instructions; a memory device having thereon modules of operational data and executable code for execution by the processor, the operational and executable data comprising; a network equipment database, the database having objects corresponding to functional rules for a corresponding network equipment element; the objects established by an operator using a Graphical User Interface; a database traversing module configured to traverse at least a portion of objects within the database; and a rules summary module which generates an output document.

In some embodiments the objects comprise statements in the Java language.

### BRIEF DESCRIPTION OF THE DRAWINGS

The present invention will be further understood from the following detailed description of embodiments of the invention, with reference to the drawings in which:

FIG. 1 illustrates an exemplary method for creation of a Rule Summary commencing from an indicated Rule Set object according to an embodiment of the present invention;

FIG. 2 illustrates an exemplary method for creation of a Rule Summary commencing from an indicated Rule Table object according to an embodiment of the present invention;

FIG. 3 illustrates an exemplary method for creation of a Rule listing commencing from an indicated Rule object according to an embodiment of the present invention;

FIG. 4 illustrates an exemplary method for rendering a Condition clause associated with a rule commencing from an indicated condition object according to an embodiment of the present invention;

FIG. 5 illustrates an exemplary method for creation of an Action clause commencing from an indicated action object according to an embodiment of the present invention;

FIG. 6 illustrates an example of summary for a Rule Table according to the results from an embodiment of the present invention;

FIG. 7 illustrates an example of a Rule Set with a problematic set of conditions; and

FIG. 8 illustrates an example of summary for a Rule Set according to the results from an embodiment of the present invention.

### DETAILED DESCRIPTION

According to an embodiment of the invention, a Graphical User Interface stores the rules established by the operator in a Rules Database in Java language.

The nature of the objects in the database are as follows in hierarchical order:

Rule Set

Rule Table

Rule

Rule Definition

Criteria

Condition

Action Attribute Info

Action

By way of example, the following segments of JAVA code illustrate the nature of the objects stored in the database.

A Rule Set is defined by the following Java code in the database:

@Entity
public class RuleSet extends BaseManagedObject
{
/** Associated Rule Set Type */
@Column(unique = true, nullable = false)
private RuleSetType ruleSetType;
/** The set of actions */
private Set<Action> defaultActions = new
HashSet<Action>( );
/** Associated Rule Tables */
private Set<RuleTable> ruleTables = new
HashSet<RuleTable>( );
}

A Rule Table object is defined by the following Java code in the database:

@Entity
public class RuleTable extends BaseManagedObject
{
/** Rule Table name */
@Column(unique = true, nullable = false)
private String name;
/** Rule Definition of the Rule */
private RuleDefinition ruleDefinition;
/** The set of Rules */
@OrderBy(“precedence DESC”)
private Set<Rule> rules = new HashSet<Rule>( );
/** RuleSets using this Rule Table */
private Set<RuleSet> ruleSets = new HashSet<RuleSet>( );
}

A Rule object is defined by the following Java code in the database:

@Entity
public class Rule extends BaseManagedObject
{
/** Rule name*/
@Column(unique = true, nullable = false)
private String name;
/** Rule precedence relative to other rules in the Rule
Table */
@Column(nullable = false)
private int precedence = 0;
/** Rule Table this Rule is contained within */
private RuleTable ruleTable;
/** The set of conditions */
private Set<Condition> conditions = new
HashSet<Condition>( );
/** The set of actions */
private Set<Action> actions = new HashSet<Action>( );
}

A Rule Definition object is defined by the following Java code in the database:

@Entity
public class RuleDefinition extends BaseManagedObject
{
/** Rule Definition name */
@Column(unique = true, nullable = false)
private String name;
/** The set of Rule tables */
private Set<RuleTable> ruleTables = new
HashSet<RuleTable>( );
/** The set of applicable criterias */
private Set<Criteria> criterias = new
HashSet<Criteria>( );
/** The set of applicable action names */
private Set<ActionAttributeInfo> actionAttributeInfos =
new HashSet<ActionAttributeInfo>( );
}

A Criteria object is defined by the following Java code in the database:

@Embeddable
public class Criteria implements Serializable
{
/** Attribute name of the criteria */
@Column(nullable = false)
private String name = null;
/** Source Context of the criteria */
@Column(nullable = false)
private SourceContextType sourceContext = null;
}

A Condition object is defined by the following Java code in the database:

@Entity
public class Condition extends BaseManagedObject
{
/** Criteria of the condition */
@Column(nullable = false)
private Criteria criteria;
/** Condition operator */
@Column(nullable = false)
private RelationalOperator operator =
RelationalOperator.EQUAL;
/** Value of the condition */
private BaseValueType value;
}

An Action Attribute info object is defined by the following Java code in the database:

@Embeddable
public class ActionAttributeInfo implements Serializable
{
/** Attribute name to be used the action */
@Column(nullable = false)
private String name = null;
/** Result Context of the action */
@Column(nullable = false)
private ResultContextType resultContext = null;
}

An Action object is defined by the following Java code in the database:

@Entity
public class Action extends BaseManagedObject
{
/** Attribute name action name */
@Column(nullable = false)
ActionAttributeInfo attributeInfo;
/** Predefined action data */
private BaseValueType data;
}

The Rule Summary Generator traverses either a subset of the objects in the database, or the entire database, and generates a Rule Summary. The contents of the Rule Summary can comprise either a rendering of a Rule Set, or a Rule Table.

In the rendering of a Rule Set there will be depicted the following:

1. Rule Set depiction contains:
List of Default Actions
List of Rule Tables

In the rendering of a Rule Table there will be depicted the following:

2. Rule Table depiction contains:
Name (String)
List of Associated Rule Sets
List of Rules

Therefore, the Rule Summary Generator can provide for the operator either a summary of a Rule Set which would contain all Rule Tables pertinent to that Rule Set, or it may provide a Rule Table which would contain all the Rules pertinent to that Rule Table. When the operator chooses to depict the Rule Set, each Rule Table depicted within the Rule Set will also depict all the Rules pertinent to that Rule Table.

In the rendering of a Rule within a Rule Table, there will be depicted the following:

3. Rule depiction contains:
Name (String)
Precedence (Integer, for ordering Rules)
List of Conditions
List of Actions
Associated Rule Table

In the rendering of a Condition within a Rule, there will be depicted the following:

4. Condition depiction contains:

A Criterion

An Operator

Value

A Criterion is something variable that exists at runtime that can be compared, such as a “Time Zone”, “Bearer Control Mode”, or “Origin Realm”.

An Operator is the specific comparison that happens within the Rule, such as “=”, “Not=”, “>”, “>=”, “<”, “<=” “Contains', “Does not Contain”.

The Value is what the Criterion is compared against, using the Operator.

In the rendering of a Action within a Rule, there will be depicted the following:

5. Action depiction contains:
Action name
Value

As described previously, the rendering of the Summary can begin at either the Rule Set or Rule Table level according to the operator's selection.

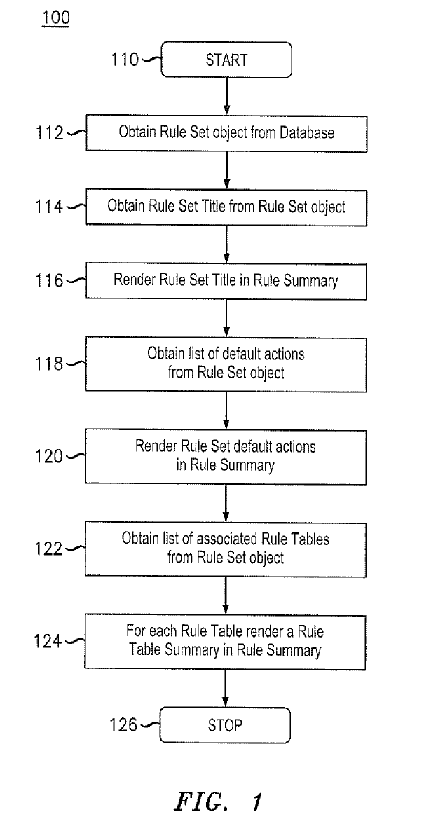

FIG. 1 illustrates an exemplary method for rendering a Rule Summary commencing with an indicated Rule Set object in the database. In the following methods, the term rendering is meant to produce a listing suitable for display on a screen or printing on hardcopy.

Method 100 may begin in step 110 and proceed to step 112 where a specified Rule Set object is retrieved from the database. At 114 the Rule Set title is obtained from the Rule Set object and rendered in the Rule Summary at step 116. At 118 the list of default actions associated with this Rule Set, if there are any, are obtained from the Rule Set object, and rendered in the Rule Summary at step 120. At step 122 the list of associated Rule Tables is obtained from the Rule Set object. At 124, for each Rule Table listed in the Rule Set object, a Rule Table summary is rendered in the Rule Summary. At 126 the method stops.

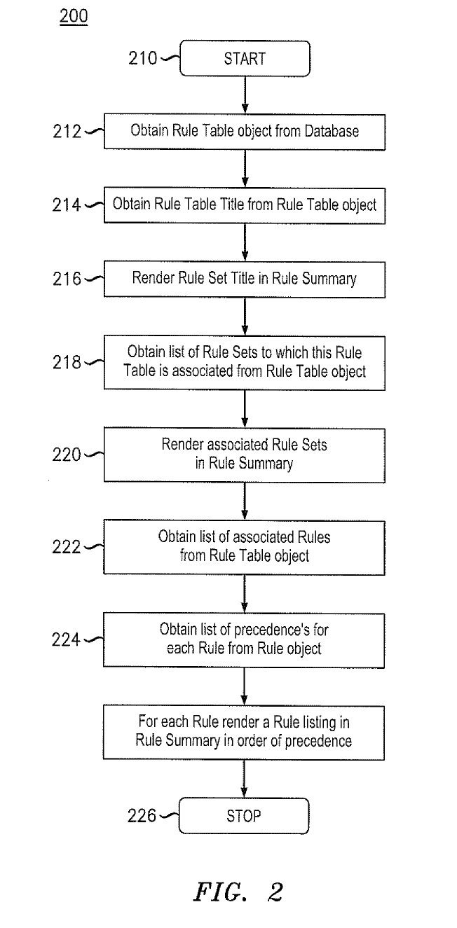

FIG. 2 illustrates an exemplary method for rendering a Rule Table summary commencing with a Rule Table object. The Rule Table summary method may be invoked as part of rendering a Rule Summary for a Rule Set, as described in method 100 supra, or may be invoked by an operator desiring a rendering of the rules associated with a specific Rule Table.

Method 200 may begin in step 210 and proceed to step 212 where a specified Rule Table object is retrieved from the database. At 214 the Rule Table title is obtained from the Rule Set object and rendered in the Rule Summary at step 216. At 218 the list of Rule Sets to which this Rule Table is associated, is obtained from the Rule Table object, and rendered in the Rule Summary at step 220. At step 222 the list of associated Rules is obtained from the Rule Table object. At 224, the list of precedences for each Rule from the list of associated Rules is obtained from the respective Rule objects. Then, for each Rule of the list of associated Rule, a Rule listing is rendered in the Rule Summary in order of precedence. At 226 the method stops.

In the rendering of the Rule Summary, Rules are displayed as IF-THEN statements. The IF portion is the Condition and the THEN portion is the Action.

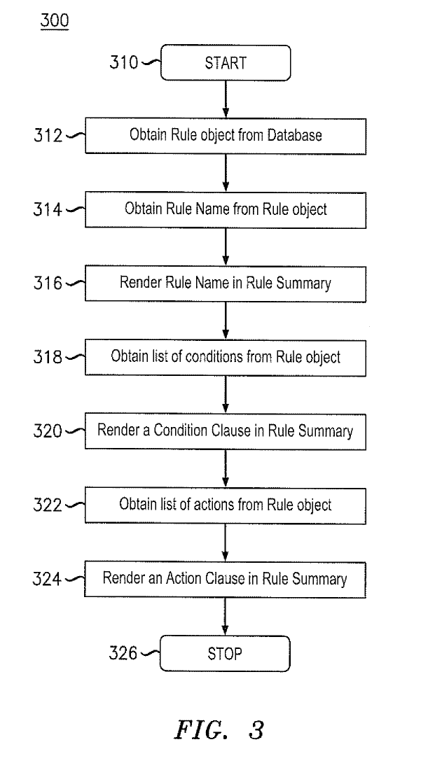

FIG. 3 illustrates an exemplary method for rendering a Rule listing commencing with a Rule object.

Method 300 may begin in step 310 and proceed to step 312 where a specified Rule object is retrieved from the database. At 314 the Rule Name or title is obtained from the Rule object and rendered in the Rule Summary at step 316. At 318 the list of Conditions for this Rule is obtained from the Rule object, and rendered in the Rule Summary at step 320 as a Condition clause. At step 322 the list of Actions for this Rule is obtained from the Rule object, and rendered in the Rule Summary at step 324 as an Action clause. At 326 the method stops.

Conditions are displayed in the Rule Summary as Condition clauses consisting of the expression [Criterion+Operator+Value]. An “AND” is appended before any subsequent Conditions because all of the conditions must be evaluated to “TRUE” before the associated action can be executed.

Likewise, Actions are displayed in the Rule Summary as Action clauses consisting of the expression [Action Name+Value]. An “AND” is appended before any subsequent Actions because all of the Actions are executed at the same time.

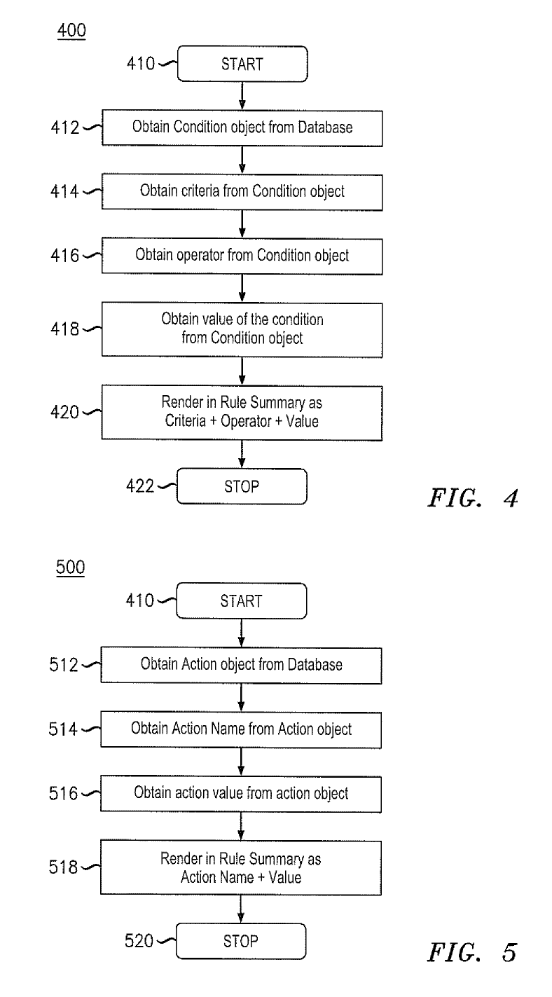

FIG. 4 illustrates an exemplary method for rendering a Condition clause listing commencing with a Condition object.

Method 400 may begin in step 410 and proceed to step 412 where a specified Condition object is retrieved from the database. At 414 the criteria is obtained from the Condition object, at 416 the operator is obtained from the Condition object, and at 418 the required value of the condition that must be met is obtained from the Condition object. At 420 these terms are rendered in the Rule Summary as per the expression [Criterion+Operator+Value]. At 422 the method stops.

FIG. 5 illustrates an exemplary method for rendering a Action clause listing commencing with a Action object.

Method 500 may begin in step 510 and proceed to step 512 where a specified Action object is retrieved from the database. At 514 the Action name is obtained from the Action object, and at 516 the action value is obtained from the Action object. At 518 these terms are rendered in the Rule Summary as per the expression [Action Name+Value]. At 520 the method stops.

Subsequent Rules in the rendering of the Rule Summary are shown as ELSE-IF statements, since those conditions will be evaluated only if the conditions for the previous Rule do not evaluate to true.

Rules with no Conditions and only an Action are shown as an ELSE statement since the Action, if reached in the evaluation process, will be executed at that point, If the Rule with no Conditions is the first Rule, then it is displayed as an EXECUTE statement.

Each section of the Rule Summary may be highlighted with varying font attributes (colour, bold, italics) to improve readability.

An example of a Rule Summary for a Rule Table may be seen in FIG. 6.

Within a Rule Table, Rules are inspected one at a time looking at the conditions of the Rule. If the condition evaluates to true, then the corresponding Action defined for that Rule is executed. Once an Action in a Rule for a Rule Table is executed, then no further Rules are evaluated within that Rule Table.

Rules are not required to have a condition defined. No condition means that the Action for a Rule is executed whenever that particular Rule is evaluated. Because Rules are evaluated in a strict order, any Rules that follow a Rule with no conditions will never be inspected or evaluated. Under normal circumstances this state is likely a form of programming error, as Rules are normally placed in the Rules Database with the expectation that they will have their conditions met at some point in time. Therefore, for a Rule, or a set of Rules to follow a Rule with no conditions—means that the actions associated with the conditions of these Rules will not be executed.

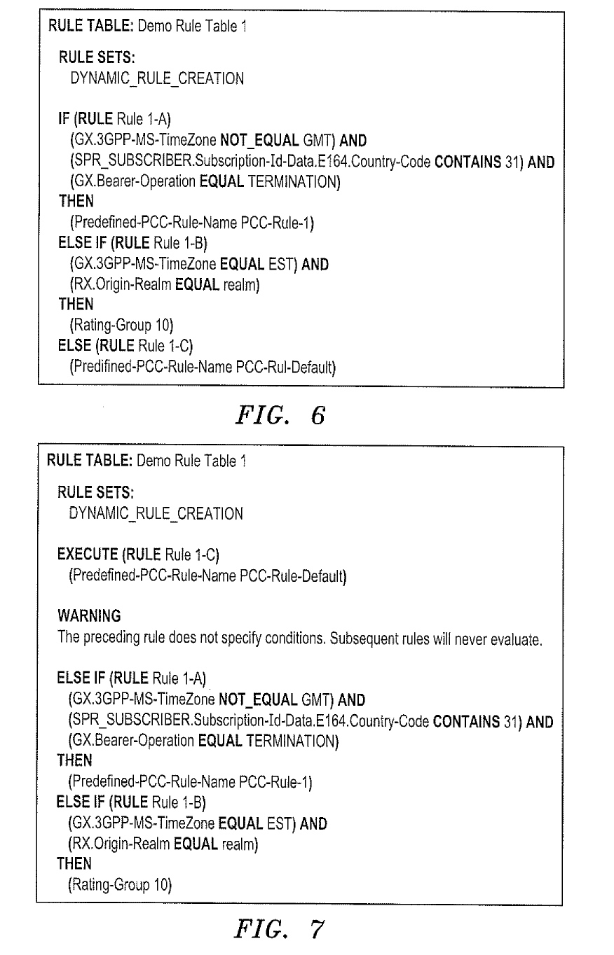

This situation is where no rules are evaluated after a Rule with no conditions is shown in FIG. 7. This situation displays a warning because there are defined Rules that will never be evaluated. The method 200 depicted in FIG. 2 may have the additional steps (not shown) of detecting such a condition, and producing a warning in the rendering of the Rule Summary.

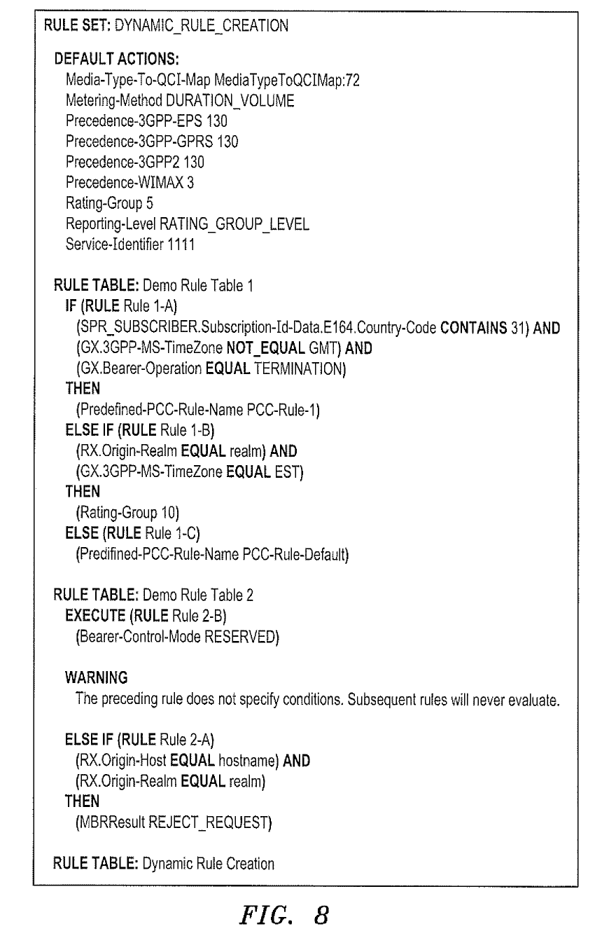

An example of a Rule Summary for a Rule Set, showing defaults and all Rule Tables may be seen in FIG. 8. Evident are the Rule Set name “DYNAMIC_RULE_CREATION”, the Default Actions, and three Rule Tables,

wherein the second Rule Table, “Demo Rule Table 2”, has resulted in the rendering of a warning statement, as there are no conditions specified for its Rule.

According to the foregoing, various exemplary embodiments provide for a method of rendering a Rule Summary from a set of rules stored in a network equipment database in a form readily cognizable by a human operator

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method for translating functional relations among objects within a network equipment database into a format more readily cognizable by an operator;
said method comprising the steps of:
receiving a database having objects corresponding to functional rules for a corresponding network equipment element, wherein said objects were established via an operator using a graphical user interface;
traversing at least a portion of objects within said database, said traversing following the functional relations among said portion of objects; and
generating an output document which reformats said functional relations into a user readable format.

2. A method as claimed in claim 1, wherein said objects comprise statements in the Java language.

3. A method as claimed in claim 1, comprising the further step of displaying said output document on a video display.

4. A method as claimed in claim 1, comprising the further step of rendering said output document on a hard copy generating device.

5. A method as claimed in claim 1, comprising the further step of specifying said at least a portion of objects.

6. A method as claimed in claim 5, wherein said specifying step specifies a rule set.

7. A method as claimed in claim 5, wherein said specifying step specifies a rule table.

8. A rule summarizing engine for translating functional relations among objects within a network equipment database into a format more readily cognizable by an operator, said rule summarizing engine comprising:
a processor for executing instructions;
a memory device having thereon modules of operational data and executable code for execution by said processor, the operational and executable data comprising;
a network equipment database, said database having objects corresponding to functional rules for a corresponding network equipment element;
said objects established by an operator using a Graphical User Interface;
a database traversing module configured to traverse at least a portion of objects within said database; and
a rules summary module which generates an output document,

9. A rule summarizing engine as claimed in claim 8, wherein said objects comprise statements in the Java language.

10. A rule summarizing engine as claimed in claim 8, wherein said at least a portion of said database comprises
a subset of objects specified by a user.

11. A rule summarizing engine as claimed in claim 10, wherein said subset of objects specified by a user comprises a rule set.

12. A rule summarizing engine as claimed in claim 10, wherein said subset of objects specified by a user comprises a rule table.
